(19) United States
(12) Patent Application Publication
(10) Pub. No.: US 2011/0274813 A1
(43) Pub. Date: Nov. 10, 2011

(54) STABILITY-IMPROVED CHOCOLATE COMPOSITIONS ON THE BASIS OF RICE STARCH

(75) Inventors: Jörg Kowalczyk, Eisenberg-Steinborn (DE); Tillmann Dörr, Hohen-Sulzen (DE); Ingrid Willibald-Ettle, Landau (DE); Christine Franck, Houthalen (BE); Rudy Wouters, Westerlo (BE)

(73) Assignee: SUDZUCKER AKTIENGESELLSCHAFT MANNHEIM/OCHSENFURT, Mannheim (DE)

(21) Appl. No.: 13/144,780

(22) PCT Filed: Jan. 19, 2010
(86) PCT No.: PCT/EP2010/000293

§ 371 Date: Jul. 15, 2011

(30) Foreign Application Priority Data
Jan. 19, 2009 (DE) 10 2009 005 928.8

(51) Int. Cl. A23G 1/32; A23L 1/187

(52) U.S. Cl. 426/579; 426/578

(57) ABSTRACT

The present invention relates to semi-solid or liquid chocolate compositions produced by providing a chocolate base mass and a rice starch gel and introducing the rice starch gel into the chocolate base mass and mixing the two components, wherein a homogenous, semi-solid or liquid chocolate composition is obtained, to products comprising the same and to a method for the production thereof.

The present invention relates to improved chocolate compositions, methods to produce the same and products comprising the same.

The main constituents of chocolate are sugar, cocoa and lecithin. By varying the cocoa content and using milk powder, the bright chocolates or milk chocolates are produced and by extremely high cocoa contents, the dark products are produced. The use of further ingredients such as hazelnuts, fruits and certain flavors provide further special variants.

Different technical methods exist for producing chocolate. The crumb method (e.g. EP 0 317 917 B1) with which the raw materials are processed directly provides products of lower quality. The conching method, by means of which an optimized aroma profile is developed by moving the chocolate mass for several hours, delivers the best results from a sensory point of view. The production of so-called lite chocolates with isomalt, maltilol, lactitol, inulin or polydextrose as described in EP 0 512 910 B1 also delivers sensorily good chocolate by conching. The production of chocolate with other carbohydrates such as isomaltulose also results in acceptable products. It is commonly agreed in the prior art that for the production of chocolate as well as for the quality features of the same, the absence of free water is essential. Free water results in agglomeration of the carbohydrates and gives the chocolate a “sandy taste”.

Liquid chocolates are also known. For the production of liquid chocolate, usually, chocolate is melted in milk and the appropriate drinkable consistency is adjusted by using starch. The chocolate is consumed while hot and would show a tendency to separate when cooling down.

Pasty, thus semi-solid, or liquid chocolate formulations are also of interest for applications like icings. Here, high amounts of fat are often used to adjust the appropriate consistency. Certain liquid chocolate compositions are often not storage-stable, i.e. have a tendency to separate their components or show microbiological instability. The flavor profile is often improvable and/or the consistency is often considered as unsatisfactory from a technological or organoleptic point of view.

The technical problem underlying the present invention is the provision of methods and products which overcome the aforementioned disadvantages. The technical problem underlying the present invention is in particular the provision of a semi-solid or liquid chocolate composition as well as products comprising the same which are characterized by a smooth consistency and adhesion of the chocolate composition, an improved taste profile, an improved processability and/or an improved storage-stability, also from a microbiological point of view.

The present invention solves the underlying technical problem by the provision of a semi-solid or liquid chocolate composition, produced by a) providing a chocolate base mass as well as a rice starch gel and b) introducing the rice starch gel into the chocolate base mass and mixing the two components, wherein a homogenous, semi-solid or liquid chocolate composition is obtained. The present invention also solves the underlying technical problem by providing a semi-solid or liquid chocolate composition, comprising 40 to 80% by weight of a chocolate base mass comprising at least one cocoa component and at least one sweetening agent, 0.5 to 10% by weight of rice starch and 20 to 50% by weight of water.

The present invention also solves the technical problem underlying the invention by providing a method for producing a semi-solid or liquid chocolate composition, wherein in a first method step, a molten chocolate base mass and a rice starch gel are provided and in a second method step, the rice starch gel is introduced into the molten chocolate base mass and is mixed into a homogenous mixture, wherein a homogenous, semi-solid or liquid chocolate composition is obtained.

The present invention also provides the teaching to provide a chocolate composition in semi-solid or liquid form which is characterized by a proportion of rice starch, in particular by the use of rice starch gel for the production of the chocolate composition, as well as by a water content which is preferably associated with the gel character of the rice starch gel and is increased compared to conventional chocolate compositions. The use of the rice starch gel for producing the semi-solid or liquid chocolate composition results in particularly smooth, easily producible chocolate compositions which can be easily spread onto other products, e.g. foodstuffs such as bakery products, and which, moreover, are characterized by a stability against separation or microbiological degradation which is improved compared to conventionally produced semi-solid or liquid chocolate compositions. The semi-solid or liquid chocolate compositions produced in this manner can be immediately used and are in particular ready-to-drink in liquid form or ready for spreading or icing in semi-solid form. The produced chocolate compositions, when used on food products, e.g. cake or other bakery products, are characterized by a uniform and good spreadability and adhesion. Moreover, the semi-solid or liquid chocolate compositions according to the invention are characterized by an advantageous, particularly creamy and full taste.

In connection with the present invention, a semi-solid chocolate composition is to be understood in particular as a pasty chocolate composition.

In a particularly preferred embodiment, the chocolate base mass is a mass which has at least one sweetening agent and at least one cocoa component as well as in a preferred embodiment, at least one additive, e.g. an emulsifier. In a particularly preferred embodiment, the chocolate base mass used according to the invention has at least one milk component. In one particularly preferred embodiment, besides the at least one cocoa component, the at least one sweetening agent, the optional at least one emulsifier, the chocolate base mass has optionally at least one milk component.

In connection with the present invention, the term “sweetening agent” is to be understood as substances which have sweetening power and are added, for example, to foods or beverages to generate a sweet taste. In connection with the present invention, the “sweetening agents” are divided in “sugar” such a saccharose, glucose or fructose which provide body and sweetening power, as well as “sweeteners”, thus substances which are not sugar but still have sweetening power and, in turn, are subdivided into “sugar substitutes”, thus sweetening agents which, in addition to a sweetening power, have a body and a physiological calorific value (bodying sweeteners) and “intense sweeteners” thus substances which usual have no or only a minor physiological calorific value.

In a preferred embodiment, the chocolate base mass of the invention is a chocolate base mass which comprises 9 to 60% by weight of at least one cocoa component, preferably 20 to 30% by weight (in each case based on the total dry weight of the chocolate base mass) of a cocoa component as well as 1 to 40% by weight (based on the total dry weight of the chocolate base mass) of at least one additive and 20 to 90% by weight, preferably 20 to 50% by weight or 50 to 80% by weight (in each case based on the total dry weight of the chocolate base mass) of at least one sweetening agent. In a particularly preferred embodiment it is provided that 35 to 75% by weight of isomaltulose (based on the total dry weight of the chocolate base mass) is present in the chocolate base mass.

The invention provides in a preferred embodiment that as cocoa component in a particularly preferred embodiment, cocoa powder, in particular fat-reduced or oil-reduced cocoa powder is used.

In connection with the present invention, additives are to be understood as such substances which, in addition to the sweetening agent and the cocoa component, can be added to the chocolate base mass according to the invention. Accordingly, said additives are substances which can optionally be used and the invention includes chocolate base masses according to the invention which comprises said substances or a selection thereof as well as chocolate base masses which comprise none or not all of the mentioned additives. The use of additives can be composed individually depending on the area of application and the requirement profile of the markets and consumers.

In connection with the present invention, an additive is also to be understood as a prebiotic which advantageously influences the nutrition-physiologically properties of the chocolate base mass in a positive manner, an intense sweetener, a sugar or a sugar substitute which influences the sweetening power of the chocolate base mass, a fat-containing component or a milk product which influences in particular the nature and the taste of the obtained beverage, or a supplement.

Supplements are to be understood as such substances which relate in particular to appearance, taste, organoleptic, nutritional value, nutrition-physiological properties, processability, shelf life or readiness for use of the chocolate base mass.

Thus, in a further preferred embodiment it is provided that the at least one additive is implemented as prebiotic, preferably inulin, polydextrose, oligofructose or galactooligosaccharide.

In connection with the present invention, a prebiotic is to be understood as an additive which selectively stimulates the growth and/or the activity of specific bacteria in the digestive tract of humans or animals, in particular bifidobacteria and/or lactobacilli, in such a manner that health-promoting effects are to be expected or occur.

In connection with the present invention, a “prebiotic” is to be understood as living microbial additional component which, by stabilizing or improving the microbial composition in the digestive tract of the human or animal consumer, promotes the health of the same. Such prebiotic microorganisms which can be used in foodstuffs, pharmaceuticals or feedstuffs are, for example: bididobacterium such as the strains B. adolescentis, B. animalis, B. bifidum, B. longum, B. thermophilum; enterococcus; lactobacillus such as the strains Lb. acidophilus, Lb. brevis, Lb. casei, Lb. cellobiosus, Lb. crispatus, Lb. delbrueckii subsp. Bulgaricus, Lb. fermentum, Lb. GG, Lb. johnsonii, Lb. lactis, Lb. plantarum, Lb. reuteri, Lb. rhamnosus, Lb. salivarius; Bacillus cereus toyoi; Bacillus cereus; Leuconostoc; Pediococcus acidilactici; Propionibacterium; Streptococcus such as the strains S. cremoris, S. infantarius, S. intermedius, S. lactis, S. salivarius subsp. thermophilis (cf. Fuller, J. Appl. Bacterial (1989)). Preferred prebiotics are bacteria of the genera lactobacillus and bifidobacterium.

In connection with the present invention, a “synbiotic” is to be understood as a mixture of at least one prebiotic and at least one prebiotic which, by improving the survival rate and increasing the number of health-promoting living microbial organisms in the gastrointestinal tract, promotes the health of the human or animal consumer, in particular by selectively stimulating the growth and/or the metabolic activity of the microbial organisms.

In a further preferred embodiment it is provided that the at least one additive is implemented as prebiotic, preferably bifidobacteria or lactobacteria. Such prebiotic bacteria cultures can preferably be implemented as dry cultures or permanent cultures. In a further preferred embodiment it is provided to use symbiotics, that is, mixtures of probiotics and prebiotics.

The invention also provides that the at least one additive is implemented as fat-containing component, for example cocoa mass, hardened vegetable fat or unhardened vegetable fat, e.g. palm oil or the like, for example also fat substitute.

The invention provides in a further preferred embodiment that the at least one additive is implemented as milk product, in particular lactose-free milk product, for example skimmed milk powder, whole milk powder, lactose-free skimmed or whole milk powder, whey extract, whey product. In this embodiment, thus a chocolate base mass comprising at least one sweetening agent, one milk product and one cocoa component, it is preferably provided to use the milk product in a quantity of 20 to 40% by weight (based on the total weight of the chocolate base mass). In particular in said latter embodiment it is preferably provided to use the sweetening agent in a quantity of 20 to 50% by weight (based on the total weight of the chocolate base mass).

In one particularly preferred embodiment, the invention provides that the at least one additive is implemented as supplement and is selected from the group consisting of aromatic substances, coloring agents, flavorings, minerals such as sodium or calcium, in particular salts such as sodium chloride, vitamins, folic acid, emulsifiers, lecithin, dietary fibers, omega-3 fatty acids, medium-chain triglycerine, phytoestrogens and asorbic acid salts or combinations thereof. In a preferred embodiment, the chocolate base mass according to the invention comprises, for example, vanillin as aromatic substance.

In a further preferred embodiment it is provided that the at least one sweetening agent is a sugar, for example saccharose, isomaltulose, glucose, fructose, maltose, lactose or a mixture of two or more thereof. In a particularly preferred embodiment, however, it is provided according to the invention that the chocolate base mass of the present invention is free of sugar or lactose.

In one particularly preferred embodiment, a carbohydrate mixture, in particular a mixture of disaccharides, nutriose and polydextrose is preferred as sweetening agent. It is of course also possible to use disaccharides alone or in mixture or to combine one or more disaccharides with nutriose and/or polydextrose.

The invention, of course, also relates In one particularly preferred embodiment to a chocolate base mass according to the invention which comprises as at least one sweetening agent at least one sugar substitute and/or one intense sweetener.

In one embodiment of the invention it is provided that the sugar substitute is in particular a sugar alcohol and is in particular selected from the group consisting of isomalt, 1,1-GPM (1-O-α-D-glucopyranisol-D-mannitol), 1,6-GPS (6-O-α-D-glucopyranosyl-D-sorbitol), 1,1-GPS (1-O-α-D-glucopyranosyl-D-sorbitol), maltodextrins, lactitol, maltitol, erythritol, xylitol, mannitol, sorbitol, maltitol syrup, hydrogenated and non-hydrogenated starch hydrolysates and a mixture of two or more thereof.

In a further preferred embodiment it is provided that the intense sweetener is selected from a group consisting of sucralose, sodium cyclamate, acesulfame K, neohesperidin-dihydrochalcone, glycyrrhizin, stevia with a rebaudioside A content of at least 95% by weight, stevioside, monellin, thaumatin, aspartame, dulcin, naringin-dihydrochalcone, neotame and a mixture of two or more thereof.

In one particularly preferred embodiment, the chocolate composition according to the invention is lactose-free.

In one particularly preferred embodiment, the chocolate composition is lactose-free, comprises isomaltulose and is harmless to teeth.

In one particularly preferred embodiment, the chocolate composition according to the invention is sugar-free, in particular glucose-free, saccharose-free and/or fructose-free.

In one particularly preferred embodiment, the chocolate composition according to the invention is suitable for diabetics and is harmless to teeth. In one particularly preferred embodiment of the present invention, a disaccharide alcohol, optionally together with an intense sweetener, is the only sweetening agent present in the chocolate composition according to the invention. In one particularly preferred embodiment, a low-glycemic sweetening agent, in particular a low-glycemic disaccharide, in particular isomaltulose, optionally together with an intense sweetener, is the only sweetening agent present in the chocolate composition according to the invention.

In one particularly preferred embodiment, isomaltulose together with an intense sweetener, optionally together with inulin, is the only sweetening agent present in the chocolate composition according to the invention.

In one particularly preferred embodiment, the invention provides that the weight ratio of the component chocolate base mass to the component rice starch gel is 4.5:1 to 1.1:1, preferably 3:1 to 1.5:1 (in each case based on the total weight of the components chocolate base mass and rice starch gel). In one particularly preferred embodiment it is provided that the rice starch gel comprises 2 to 20% by weight, preferably 3 to 18% by weight, in particular 5 to 15% by weight of rice starch (based on the total weight of the rice starch gel). The remaining component of the rice starch gel is preferably water and adds up to 100% by weight based on the total weight of the rice starch gel.

In one particularly preferred embodiment, the chocolate base mass thus has at least one sweetening agent, e.g. a carbohydrate, at least one cocoa component, lecithin and milk powder.

The production of the chocolate base mass according to the invention can be carried out by simple mixing of the components, e.g. in a Lödige mixer or by using the fluidized bed process, preferably at temperatures of 30 to 50° C.

In a particularly preferred manner, the chocolate base mass can be traditionally produced by mixing and rolling. In one particularly preferred embodiment, the chocolate base used according to the invention is a finished chocolate, for example such a chocolate which has been produced by conching. In a particularly preferred embodiment, a chocolate base mass used according to the invention is melted in particular at 40 to 80° C., preferably 50 to 80° C.

In a further preferred embodiment it is provided that the chocolate composition comprises 20 to 50% by weight of water, in particular 30 to 45% by weight, preferably 32 to 44% by weight of water (based on the total weight of the chocolate composition). In a further preferred embodiment it is provided that the chocolate composition comprises 0.5 to 10% by weight, preferably 1 to 9% by weight, in particular 2 to 8% by weight of rice starch (based on the total weight of the chocolate composition). In a further preferred embodiment it is provided that the chocolate composition according to the invention comprises 40 to 80% by weight, in particular 50 to 70% by weight, in particular 52 to 65% by weight of chocolate base mass.

According to the invention it is preferred to also incorporate almond paste, honey coffee extract and other fine-ground products or pasty substances into the chocolate base mass. In a particularly preferred embodiment, stabilizers such as xanthan, polysaccharides and emulsifiers such as mono- and diglycerides or saccharose-mono-fatty acid ester can also be used. In a preferred embodiment, aromatizing can be carried out in an advantageous manner by fruit preparations or natural and synthetic flavors.

According to the invention, pasteurization of the finished product is also possible in a preferred embodiment.

In connection with the present invention, all weight percentages, in particular described by the specified ranges for the weight percentages for components of mixtures, in particular chocolate compositions, chocolate base mass and rice starch gel are to be understood such that the components in the mixture referred to add up to 100% by weight.

In a particularly preferred embodiment, the chocolate composition is a pudding, a cream, an icing, a spread, a body paint, a cake icing or a drinking chocolate.

In one particularly preferred embodiment, the present invention also relates to products, in particular groceries, foodstuff or stimulants, e.g. bakery products, aerated confectionary, confectionary or the like which comprise a semi-solid or liquid chocolate composition according to the invention, are preferably coated with the same, or comprise the same in the form of a filling. In a particularly preferred embodiment, such products according to the invention comprise 10 to 90% by weight, preferably 20 to 80% by weight, in particular 30 to 70% by weight, preferred 40 to 60% by weight of the chocolate composition according to the invention.

In a further embodiment, the present invention also relates to a method for the production of a semi-solid or liquid chocolate composition, wherein in a first method step, a chocolate base mass, in particular a heated and molten chocolate base mass and a rice starch gel, preferably a heated rice starch gel are provided and in a second method step, the rice starch gel is introduced in the heated form into the molten and heated chocolate base mass and is mixed into a homogenous mixture wherein a homogenous, semi-solid or liquid chocolate composition is obtained. In a particularly preferred embodiment, the chocolate base mass is heated to a temperature of 40 to 80° C., in particular 50 to 70° C. In a particularly preferred embodiment, the rice starch gel is heated to a temperature of 60 to 90° C., in particular 70 to 80° C. prior to adding it to the chocolate base mass.

In a particularly preferred embodiment, the rice starch gel is produced in that rice starch is mixed with water at an increased temperature, e.g. 60 to 90° C., preferably 60 to 65° C. and a gel is obtained. In a particularly preferred embodiment, the heated rice starch gel is introduced in portions and sequentially into the chocolate base mass, e.g. in two, three or more successive method steps. Particularly preferred, the rice starch gel is introduced in a continuous manner into the chocolate base mass. In a particularly preferred embodiment, the introduction of the rice starch gel takes place over a period of 1 to 60 minutes, in particular 5 to 30 minutes, in particular 6 to 20 minutes, preferably 7 to 15 minutes.

In one particularly preferred embodiment, the aforementioned method consists of the aforementioned method steps, i.e., no further method steps for producing the ready-to-use, in particular ready-to-drink, or ready-to-ice or ready-to-spread chocolate composition is used.

Further advantageous configurations arise from the sub-claims.

The invention is illustrated in more detail by means of the following examples.

### EXAMPLE 1

### Spread with Extended Energy Release

A) 200 g chocolate base mass is produced with isomaltulose and inulin as follows.

20% by weight of cocoa powder (Kessko KP 10/12) are intimately mixed with 41.95% by weight of isomaltulose, 0.05% by weight of vanillin and 5% by weight of inulin (Orafti® HP) in a Z-mixer. A sufficient quantity of fat, namely 32.5% by weight (Kernetta 937, Rau und Neusser, palm oil) and 0.5% by weight of lecithin is added to said dry mixture and mixed at 40° C. for 10 minutes so that a pasty mixture is obtained. Subsequently, the mass is processed via a roller mill system and a particle size of ≦20 μm is set.

Weight percentages are based in each case on total dry weight of the chocolate base mass.

B) 158 g rice starch gel (150 g water and 8 g Remyline AX-DR)

C) The chocolate base mass is melted in a thermostatically-controllable mixer (max. temperature 65° C.) and the rice starch gel heated to 70° C. is added in portions over a period of 15 minutes. Subsequently, it is stirred for another three minutes at this temperature and is filled into hot-sterilized jars.

At room temperature, the product melts smoothly and is easy to spread.

### EXAMPLE 2

### Cake Icing

A) 200 g chocolate base mass with saccharose (powdered sugar) is produced as follows.

For producing the chocolate base mass, 46.95% by weight of saccharose is intimately mixed with 20% by weight of cocoa powder (Kessko KP 10/12) and 0.05% by weight of vanillin in a Z-mixer. A sufficient quantity of fat, namely 32.5% by weight (Kernetta 937, Rau und Neusser, palm oil) and 0.5% by weight of lecithin is added to said dry mixture and is mixed at 40° C. for 10 minutes so that a pasty mixture is obtained. Subsequently, the mass is processed via a roller mill system and a particle size of ≦20 μm is set.

Weight percentages are based in each case on total dry weight of the chocolate base mass.

B) 110 g rice starch gel (100 g water and 10 g rice starch, Remyline AX-DR)

C) The chocolate base mass is melted in a thermostatically-controllable mixer (max. temperature 65° C.) and the rice starch gel heated to 80° C. is added in portions over a period of 15 minutes. Subsequently, it is stirred for another three minutes at this temperature and is filled into an aluminum bag which is subsequently sealed.

At room temperature, the product is solid and can be liquefied in a water bath at 50 to 60° C. The product spreads evenly on the cake surface and forms a glossy film which then also adheres well.

### EXAMPLE 3

### Christmas Chocolate Drink

A) 200 g chocolate base mass is produced with isomaltulose and inulin as follows.

20% by weight of cocoa powder (Kessko KP 10/12) are intimately mixed with 41.95% by weight of isomaltulose, 0.05% by weight of vanillin and 5% by weight of inulin (Orafti® HP) in a Z-mixer. A sufficient quantity of fat, namely 32.5% by weight (Kernetta 937, Rau und Neusser, palm oil) and 0.5% by weight of lecithin is added to said dry mixture and is mixed at 40° C. for 10 minutes so that a pasty mixture is obtained. Subsequently, the mass is processed via a roller mill system and a particle size of ≦20 μm is set.

Weight percentages are based in each case on total dry weight of the chocolate base mass.

B) 180 g rice starch gel (170 g water and 10 g rice starch; Remyline AX-BR)

2 g apple-cinnamon flavor (Symrise)

0.05 g acesulfam K

C) The chocolate is melted in a thermostatically-controllable mixer (max. temperature 65° C.), flavor and intense sweetener are added and the rice starch gel heated to 80° C. is added thereto in portions over a period of 15 minutes. Subsequently, it is stirred for another 3 minutes at this temperature, pasteurized at 85° C. within a short time and filled into sterile containers.

At room temperature, the product is homogenous, stable against sedimentation and has a creamy and full taste. Even after a storage time of three months at room temperature, the product is microbiologically stable and exhibits the above-described advantageous taste profile.

### EXAMPLE 4

The spreads, cake icings and chocolate drinks produced in the examples 1 to 3 were also produced in an analog manner in each case with other chocolate base masses instead of the chocolate base masses set forth in the examples 1 to 3.

In this manner, a first chocolate base mass was produced with the following recipe and used according to the invention:

29.93% by weight of saccharose (powdered sugar)

20% by weight of cocoa powder

32.5% by weight of fat

7% by weight of isomalt ST-PF (standard, powdered form)

0.02% by weight of sucralose

0.5% by weight of lecithin

0.05% by weight of vanillin

10% by weight of Orafti® GR (inulin)

A second chocolate base mass that is used had the following composition:

20% by weight of cocoa powder

32.5% by weight of fat

36.908% by weight of isomalt ST-PF

0.042% by weight of sucralose

0.5% by weight of lecithin

0.05% by weight of vanillin

10% by weight of Orafti® LGI (inulin)

A third chocolate base mass used according to the invention had the following composition:

20% by weight of saccharose

20% by weight of cocoa powder

32.5% by weight of fat

19.927% by weight of isomalt ST-PF

0.023% by weight of sucralose

0.5% by weight of lecithin

0.05% by weight of vanillin

7% by weight of Orafti® P95 (inulin)

A fourth chocolate base mass that was used had the following composition:

13.64% by weight of saccharose

18.18% by weight of cocoa powder

29.02% by weight of isomalt ST-PF

29.55% by weight of fat

0.025% by weight of sucralose

0.45% by weight of lecithin

0.045% by weight of vanillin

9.09% by weight of Orafti® HP

The cocoa powder and the fat are the products Kessko KP 10/12 and Kernetta, Rau und Neusser (palm oil) specified in example 1.

As lecithin, Topicitin NGM, Cargill was used in all four examples.

The products obtained were characterized by the aforementioned advantages.

1. A semi-solid or liquid chocolate composition, produced by:
a) providing a chocolate base mass and a rice starch gel; and
b) introducing the rice starch gel into the chocolate base mass and mixing the two components, wherein a homogenous, semi-solid or liquid chocolate composition is obtained.

2. The chocolate composition according to claim 1, wherein the weight ratio of chocolate base mass to rice starch gel is 4.5:1 to 1.1:1 based on the total weight of the components.

3. The chocolate composition according to claim 1, wherein the rice starch gel comprises 2 to 20% by weight of rice starch.

4. The chocolate composition according to claim 1, wherein the chocolate composition comprises 20 to 50% by weight of water based on the total weight of the chocolate composition.

5. The chocolate composition according to claim 1, wherein the chocolate composition comprises 0.5 to 10% by weight of rice starch based on the total weight of the chocolate composition.

6. The chocolate composition according to claim 1, wherein the chocolate composition comprises 40 to 80% by weight of chocolate base mass based on the total weight of the chocolate composition.

7. The chocolate composition according to claim 1, wherein introducing the rice starch gel is carried out in portions and sequentially.

8. The chocolate composition according to claim 2, wherein the liquid chocolate composition is obtained, the liquid chocolate composition selected from the group consisting of pudding, a cream, an icing, a topping, a body paint, a spread and a drinking chocolate.

9. A semi-solid or liquid chocolate composition, comprising 40 to 80% by weight of a chocolate base mass, the chocolate base mass including at least one sweetening agent, 0.5% to 10% by weight of rice starch and 20 to 50% by weight of water.

10. A product, comprising a semi-solid or liquid chocolate composition according to claim 1.

11-13. (canceled)

14. A product, comprising a semi-solid or liquid chocolate composition according to claim 9.

15. A method for producing a semi-solid or liquid chocolate composition according to claim 1, wherein in a first method step, the chocolate base mass and the rice starch gel are provided and in a second method step, the rice starch gel is introduced into the molten chocolate base mass and mixed into a homogenous mixture, wherein a homogenous, semi-solid or liquid chocolate composition is obtained.

16. The method according to claim 15, wherein the rice starch gel is introduced in portions and sequentially into the chocolate base mass.

17. The method according to claim 15, wherein the provided rice starch gel is preheated.
